(19) United States
(12) Patent Application Publication
(10) Pub. No.: US 2018/0029621 A1
(43) Pub. Date: Feb. 1, 2018

(54) Wheeled Shopping Tote

(71) Applicant: Patricia Najdek, Manorville, NY (US)

(72) Inventor: Patricia Najdek, Manorville, NY (US)

(21) Appl. No.: 15/656,250

(22) Filed: Jul. 21, 2017

Related U.S. Application Data
(60) Provisional application No. 62/367,403, filed on Jul. 27, 2016.

(51) Int. Cl. B62B 1/20; B62B 1/22

(52) U.S. Cl. CPC B62B 1/208; B62B 1/22; B62B 2301/252

(57) ABSTRACT

A wheeled shopping tote. The wheeled shopping tote includes a plurality of rods removably secured to one another. The wheeled shopping tote is configured to maintain an extended configuration during use and a collapsed configuration for storage. A handle is disposed on the uppermost rod. The handle is an open loop in one embodiment or a T-shaped member in an alternate embodiment. A plurality of fasteners such as hooks are disposed on the base. Each fastener is configured to secure an item to the wheeled shopping tote, such as a shopping bag filled with items. One or more wheels are rotatably secured to the lowermost rod. The wheeled shopping tote allows users to easily support and transport shopping bags or other items.

### CROSS REFERENCE TO RELATED APPLICATIONS

This application claims the benefit of U.S. Provisional Application No. 62/367,403 filed on Jul. 27, 2016. The above identified patent application is herein incorporated by reference in its entirety to provide continuity of disclosure.

### FIELD OF THE INVENTION

The present invention relates to shopping totes. More specifically, the present invention provides a wheeled shopping tote having a plurality of hooks for easily transporting shopping bags that is collapsible via a telescopic configuration or a folding configuration.

### BACKGROUND OF THE INVENTION

Many individuals transport purchased items in bags to and from various locations when shopping at malls, stores, and other shopping centers. At many such shopping centers, there are no shopping carts or other devices provided to assist an individual with bag transport. As a result, individuals may make numerous trips to their vehicles to store all of their shopping bags, which can be tiring and time consuming.

Other individuals may choose to place some of their smaller bags into a larger bag for easier transport. However, this still requires the individual to carry the full load by hand. Additionally, items stored in bags that have been placed into other bags can become damaged, and the items can easily fall out and become even more damaged. While transporting bags of items via walking or via public transportation, there is not a reliable means for reducing the carry weight of the items, making them easier to transport. Carrying one or more heavy bags can lead to discomfort and even injury. In light of the above concerns, the present invention provides a wheeled shopping tote having a plurality of hooks for supporting shopping bags thereon, and wheels for easily transporting the shopping bags.

In light of the devices disclosed in the prior art, it is submitted that the present invention substantially diverges in design elements from the prior art and consequently it is clear that there is a need in the art for an improvement to existing animal deterring devices. In this regard the instant invention substantially fulfills these needs.

### SUMMARY OF THE INVENTION

In view of the foregoing disadvantages inherent in the known types of shopping caddies now present in the prior art, the present invention provides a wheeled shopping tote wherein the same can be utilized for providing convenience for the user when transporting a number of shopping bags. The wheeled shopping tote comprises a base having an upper end a lower end, the base maintaining a telescopic configuration, and a handle disposed on the upper end of the base. A plurality of hooks are disposed on the base; and one or more wheels are rotatably secured to the lower end of the base. The plurality of hooks each support a shopping bag thereon, and the one or more wheels allows multiple bags to be transported simultaneously.

An object of the present invention is to provide a wheeled shopping tote that facilitates the transport of multiple shopping bags.

Another object of the present invention is to provide a wheeled shopping tote that is collapsible, allowing it to be carried in a pocket book or bag for convenience.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the wheeled shopping tote.

FIG. 2 shows an exploded view of the wheeled shopping tote.

FIG. 3 shows an alternate embodiment of the wheeled shopping tote.

### DETAILED DESCRIPTION OF THE INVENTION

Reference is made herein to the attached drawings. Like reference numerals are used throughout the drawings to depict like or similar elements of the wheeled shopping tote. For the purposes of presenting a brief and clear description of the present invention, the preferred embodiment will be discussed as used for facilitating easy transport of bagged items. The figures are intended for representative purposes only and should not be considered to be limiting in any respect.

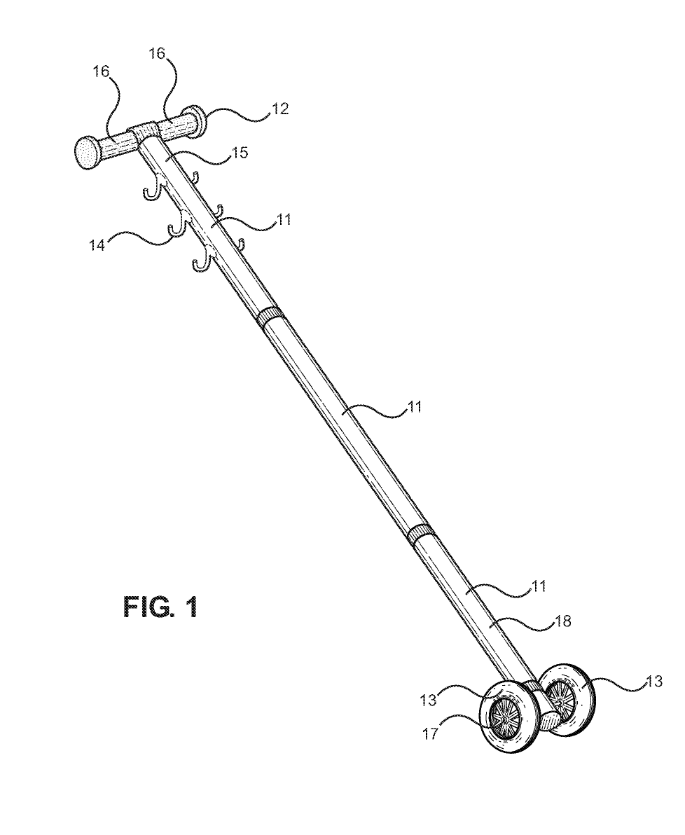

Referring now to FIG. 1, there is shown a perspective view of the wheeled shopping tote. The wheeled shopping tote comprises a body 10 having a plurality of rods 11. The plurality of rods 11 are removably secured to one another so that the wheeled shopping tote may be collapsed when not in use. In the shown embodiment, three rods 11 are disposed in linear arrangement when in the extended position. However, additional rods 11 may be utilized to alter the length of the wheeled shopping tote. In some embodiments, the rods 11 are configured to be in telescopic arrangement with one another, such that the height of the body 10 can be adjusted.

A handle 12 is disposed on an uppermost rod 15. In the shown embodiment, the handle is T-shaped and includes hand grips 16 that extend in opposing directions from each other. The wheeled shopping tote further includes wheels 13 disposed on a lowermost rod 18. The wheels 13 support the wheeled shopping tote on the ground and allow it to be easily transported by rolling it along the ground. In the shown embodiment, the wheeled shopping tote includes two wheels 13 rotatably connected to an axle 17, wherein the axle 17 is affixed to the lowermost rod 18.

A plurality of fasteners 14 are disposed on at least one of the rods 11. The fasteners 14 are configured to secure a shopping bag to the wheeled shopping tote. In the shown embodiment, the fasteners 14 are disposed in a linear arrangement on the uppermost rod 15. The fasteners 14 are shown as hooks in the illustrated embodiment, but may include other fasteners suitable for securing a shopping bag to the wheeled shopping tote, such as clips or hook and loop fasteners.

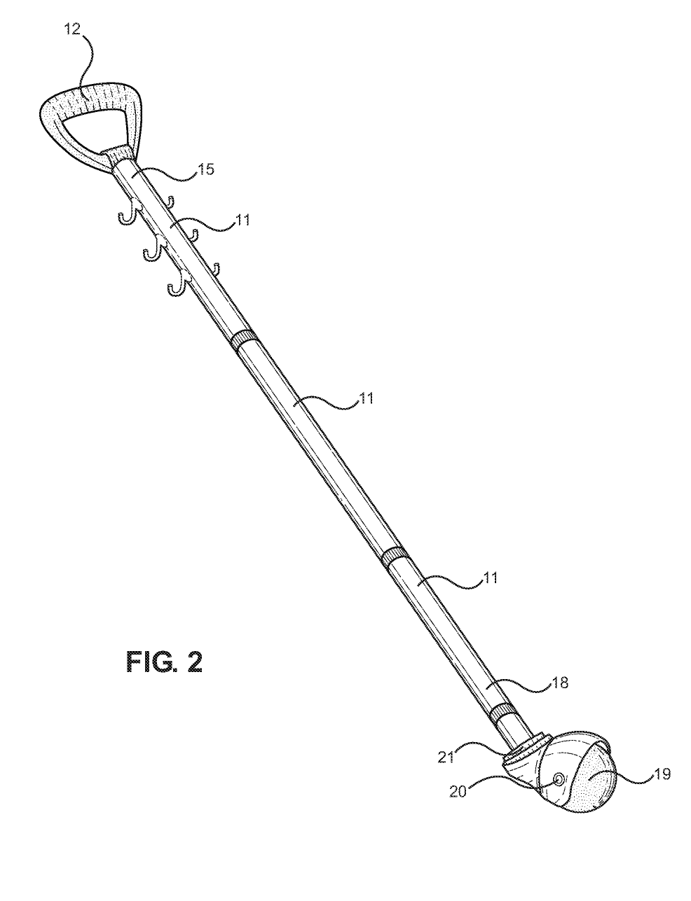

Referring now to FIG. 2, there is shown a perspective view of an alternate embodiment of the wheeled shopping tote. In the shown embodiment, the wheeled shopping tote is supported on the ground by a roller ball 19 rotatably affixed to a housing 20, wherein the housing is secured to the lowermost rod 18 via a swivel connection 21. The handle 12 is an open loop with opposing ends affixed to the upper most rod 15. In this embodiment, the handle 12 can be canvas or another fabric in order to reduce the overall weight of the wheeled shopping tote. Further, in the shown embodiment the fasteners 14 are disposed in a non-linear arrangement and are staggered so that a greater number of shopping bags can be secured to the wheeled shopping tote.

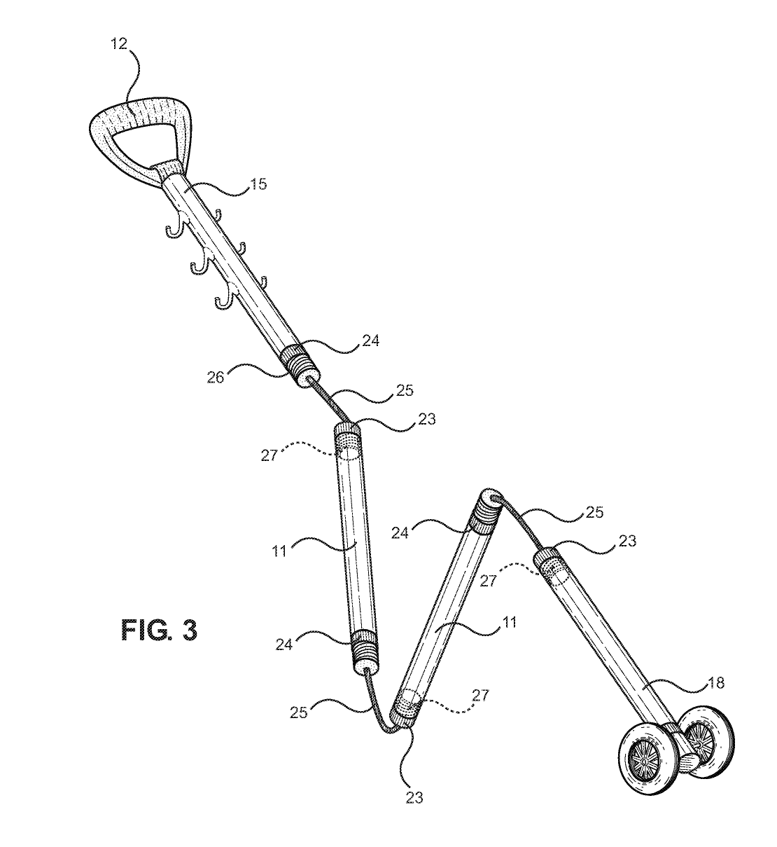

Referring now to FIG. 3, there is shown an exploded view of the wheeled shopping tote. The wheeled shopping tote is collapsible so that it takes up less space when stored or otherwise not in use. An elastic cord 25 is affixed to upper and lower ends 23, 24 of each rod 11. The elastic cord 25 allows the rods 11 to stay connected when in the collapsed configuration so that rods 11 are not misplaced. In some embodiments, the rods 11 are secured via tension from the elastic cord 25. In other embodiments, the upper and lower end 23, 24 are configured to maintain a threaded connection for increased stability during use.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wheeled shopping tote, comprising:
a plurality of rods configured to maintain either one of an expanded configuration or a collapsed configuration;
a handle disposed an uppermost rod of the plurality of rods;
one or more fasteners disposed on at least one rod of the plurality of rods;
one or more wheels rotatably secured to a lowermost rod of the plurality of rods.

2) The wheeled shopping tote of claim 2, wherein the one or more fasteners are disposed on the uppermost rod of the plurality of rods.

3) The wheeled shopping tote of claim 3, wherein the one or more fasteners comprises one or more hooks.

4) The wheeled shopping tote of claim 3, wherein the one or more fasteners comprises one or more clips.

5) The wheeled shopping tote of claim 1, wherein the handle comprises an open loop.

6) The wheeled shopping tote of claim 1, wherein the handle comprises a T-shape member.

7) The wheeled shopping tote of claim 1, wherein the handle comprises a triangular perimeter.

8) The wheeled shopping tote of claim 1, wherein each rod of the plurality of rods is removably securable to at least one other rod of the plurality of rods, such that the plurality of rods are configured to be separable from each another and maintain so as to maintain the collapsed configuration.

9) The wheeled shopping tote of claim 1, wherein the one or more wheels comprises a roller ball affixed to a housing, wherein the housing is rotatably affixed to a lowermost rod of the plurality of rods.

10) The wheeled shopping tote of claim 1, wherein the one or more wheels comprises a pair of opposing wheels rotatably affixed to opposing sides of an axle, wherein the axle is affixed to a lowermost rod of the plurality of rods.

11) The wheeled shopping tote of claim 1, further comprising an elastic cord affixed to each of a lower end and an upper end of each rod of the plurality of rods.
